(19) United States
(12) Patent Application Publication
(10) Pub. No.: US 2006/0145613 A1
(43) Pub. Date: Jul. 6, 2006

(54) Plasma display apparatus

(76) Inventor: Hong Tak Kim, Taegu-si (KR)

Correspondence Address: FLESHNER & KIM, LLP, P.O. BOX 221200, CHANTILLY, VA, 20153, US

(21) Appl. No.: 11/321,068

(22) Filed: Dec. 30, 2005

(30) Foreign Application Priority Data
Dec. 31, 2004 (KR) 10-2004-0118554

(51) Int. Cl. H01J 17/49

(52) U.S. Cl. 313/582

(57) ABSTRACT

A plasma display apparatus according to an embodiment of the present invention includes horizontal barrier ribs and vertical barrier ribs formed on a lower substrate, for partitioning a discharge cell, an address electrode formed under the discharge cell, a scan bus electrode and a sustain bus electrode formed on an upper substrate opposite to the lower substrate, wherein at least one or more of the scan bus electrode and the sustain bus electrode comprise base units crossing the address electrode, and at least two or more projections projecting from the base units in one discharge cell. The base unit or the projections of the scan bus electrode and the sustain bus electrode are closely located at the center of the discharge cell. Furthermore, the projections are included. Furthermore, a manufacturing time and cost can be decreased because transparent electrodes are not formed.

### BACKGROUND

1. Field of the Invention

The present invention relates to a plasma display apparatus, and more particularly, to a plasma display apparatus in which only bus electrodes are used without transparent electrodes, thus lowering the manufacturing cost and enhancing discharge efficiency.

2. Discussion of Related Art

A plasma display panel (hereinafter, referred to as “PDP) displays images including characters and/or graphics by exciting phosphors with vacuum ultraviolet rays (VUV) having a wavelength of about 147 nm generated during the discharge of a mixed inert gas such as He+Xe, Ne+Xe or He+Ne+Xe. The PDP can be easily made thin and large, and it can provide greatly increased image quality with the recent development of the relevant technology. More particularly, a three-electrode AC surface discharge type PDP has advantages of lower voltage driving and longer product lifespan since wall charges are accumulated on a surface upon discharge and electrodes are protected from sputtering generated by a discharge.

FIG. 1 is a perspective view illustrating the structure of a plasma display apparatus in the related art.

Referring to FIG. 1, the related art plasma display apparatus includes a scan electrode Y and a sustain electrode Z formed on a bottom surface of an upper substrate 10, and address electrodes X formed on a lower substrate 20. The scan electrode Y includes a transparent electrode 11a, and a metal bus electrode 11b, which has a line width smaller than that of the transparent electrode 11a and is disposed at one side edge of the transparent electrode. Furthermore, the sustain electrode Z includes a transparent electrode 12a, and a metal bus electrode 12b, which has a line width smaller than that of the transparent electrode 12a and is disposed at one side edge of the transparent electrode.

The transparent electrodes 11a, 12a are generally form of Indium Tin Oxide (ITO) and are formed on a bottom surface of the upper substrate 10. The metal bus electrodes 11b, 12b are generally formed of metal having a good conductivity, such as chromium (Cr), silver (Ag) or copper (Cu), and are formed on the transparent electrodes 11a, 12a. The metal bus electrodes 11b, 12b function to reduce a voltage drop caused by the transparent electrodes 11a, 12a having high resistance. The metal bus electrodes 11b, 12b can be formed of a single metal or two or more metal layers in order to prevent the diffusion into an upper dielectric layer 13. On the bottom surface of the upper substrate 10 in which the scan electrode Y and the sustain electrodes Z are formed in parallel is laminated the upper dielectric layer 13 and a protection layer 14. Wall charges generated during the discharge of plasma are accumulated on the upper dielectric layer 13. The protection layer 14 functions to prevent the upper dielectric layer 13 from being damaged by sputtering generated during the discharge of plasma. The protection layer 14 is formed of a material having a high emission coefficient of secondary electrons and thus functions to improve emission efficiency of secondary electrons. Magnesium oxide (MgO) is generally used as the protection layer 14.

A lower dielectric layer 23 and barrier ribs 22 are formed on the lower substrate 20 in which the address electrodes X are formed. A phosphor layer 24 is coated on the surfaces of the lower dielectric layer 23 and the barrier ribs 22. The address electrodes X are formed to cross the scan electrode Y and the sustain electrode Z. The barrier ribs 22 are formed parallel to the address electrodes X in a stripe form, and function to prevent ultraviolet rays generated by a discharge and a visible ray from leaking to neighboring discharge cells. The phosphor layer 24 is excited with ultraviolet rays generated during the discharge of plasma to generate any one visible ray of red, green and blue. An inert mixed gas is injected into discharge spaces provided between the upper substrate 10 and the barrier ribs 22 and between the lower substrate 20 and the barrier ribs 22.

In the related art plasma display apparatus constructed above, a cell is selected by a counter discharge between the address electrode X and the scan electrode Y. A discharge is sustained by a surface discharge between the scan electrode Y and the sustain electrode Z. At this time, in the discharge cell, the phosphor layer 24 emits light by ultraviolet rays generated during the sustain discharge, so that a visible ray generated from the phosphor layer penetrates the upper substrate and is then radiated outside the cell. As a result, the plasma display apparatus displays a specific image on the screen.

The plasma display apparatus that operates as described above implements gray levels necessary for displaying images by controlling a discharge sustain period of a cell, i.e., a sustain discharge number depending on video data.

The barrier ribs 22 shown in FIG. 1 can have a stripe shape consisting of only vertical barrier ribs shown in FIG. 2, or a closed type consisting of vertical barrier ribs and horizontal barrier ribs shown in FIG. 3. In the case of a PDP to which the stripe type barrier ribs shown in FIG. 2 is applied, an exhaust is convenient, but the phosphor layer is coated only on the bottom surface of the cell and on the barrier ribs 22 formed at both sides of the cell. Therefore, there are problems in that emission efficiency is low and electrical interference (crosstalk) is generated between discharge cells that are vertically adjacent to each other since a phosphor coating area is relatively small. Meanwhile, in the case of a PDP to which the closed type barrier ribs shown in FIG. 3 is applied, cells are partitioned by horizontal barrier ribs 22b and vertical barrier ribs 22a, and the phosphor layer is coated on four sides of the horizontal barrier ribs 22b and the vertical barrier ribs 22a that surround the bottom surface of the cell and the cells. Therefore, since the phosphor coating area is relatively wide, emission efficiency can be improved and electrical interference (crosstalk) between discharge cells that are adjacent to each other vertically and horizontally can be prevented.

In the related art plasma display apparatus, however, after the transparent electrodes 11a, 12a having a relatively high resistance are formed on the upper substrate 10, the metal electrodes 11b, 12b having a good conductivity are formed on the transparent electrodes 11a, 12a. Therefore, a number of processes, such as a vacuum deposition process, a pattern formation process and a chemical etching process, for forming the transparent electrodes 11a, 12a, are required. For this reason, the cost in process is increased and environmental problems can be generated due to the number of processes. Furthermore, the manufacturing cost is increased since the transparent electrodes 11a, 12a are formed using indium (In), i.e., rare metal. Furthermore, in the case of the related art plasma display apparatus of an ITO-less type not having the transparent electrodes, the metal electrodes 11b, 12b are formed at the outer walls of the discharge cells, which lengthens a distance between the metal electrodes. Therefore, not only discharge efficiency is lowered, but also emission efficiency is also lowered since a discharge distance becomes long.

### SUMMARY OF THE INVENTION

Accordingly, the present invention has been made in view of the above problems, and it is an object of the present invention to provide a plasma display apparatus in which the manufacturing cost can be lowered by using only bus electrodes without transparent electrodes, and discharge efficiency can be enhanced by improving the structure of the bus electrodes.

A plasma display apparatus according to a first aspect of the present invention includes horizontal barrier ribs and vertical barrier ribs formed on a lower substrate, for partitioning a discharge cell, an address electrode formed under the discharge cell, a scan bus electrode and a sustain bus electrode formed on an upper substrate opposite to the lower substrate. At least one or more of the scan bus electrode and the sustain bus electrode include base units crossing the address electrode, and at least two or more projections projecting from the base units in one discharge cell.

In this case, the projections are projected toward the base units of counter bus electrodes that are opposite to each other.

Furthermore, the projection of the scan bus electrode and the projection of the sustain bus electrode are parallel to each other.

A distance between the projections may be asymmetrical.

A width of the projections may be asymmetrical.

At least one or more of the projections may be overlapped with the address electrode.

The base units are partially overlapped with the horizontal barrier ribs.

The projection of the scan bus electrode and the projection of the sustain bus electrode have the same number in one discharge cell. The projections are alternately projected together with the projections of the counter bus electrodes.

A distance from the end of the projection to the base unit of the counter bus electrode is shorter than the length of the projection.

A plasma display apparatus according to a second aspect of the present invention includes barrier ribs formed on a lower substrate, for partitioning a discharge cell, an address electrode formed under the discharge cell, a scan bus electrode and a sustain bus electrode formed on an upper substrate opposite to the lower substrate. The scan bus electrode and the sustain bus electrode include base units crossing the address electrode, and at least one or more projections projecting from the base units in one discharge cell. The projections are projected in a direction opposite to the base units of counter bus electrodes that are opposite to each other.

In this case, the projection of the scan bus electrode and the projection of the sustain bus electrode are parallel to each other.

Furthermore, the projections have a width, which is substantially narrower than that of the base units.

Furthermore, the projections are parallel to the address electrode.

The projection of the scan bus electrode and the projection of the sustain bus electrode have the same number in one discharge cell.

The projections include a first projection, which is connected to the base unit and has a narrow width, and a second projection having a width wider than that of the first projection.

In this case, the first projection and the second projection are metal electrodes. The second projection of the scan bus electrode and the second projection of the sustain electrode have the same number in one discharge cell.

The plasma display apparatus further includes a black layer formed between the base unit and the upper substrate.

The black layer has a width wider than that of the base units.

### BRIEF DESCRIPTION OF THE DRAWINGS

FIG. 1 is a perspective view illustrating the structure of a plasma display apparatus in the related art;

FIG. 2 is a plan view illustrating the structure of a stripe type barrier rib in the related art;

FIG. 3 is a plan view illustrating the structure of a closed type barrier rib structure in the related art;

FIG. 4 is a plan view illustrating the construction of a plasma display apparatus according to a first embodiment of the present invention;

FIG. 5 is a cross-sectional view illustrating the construction of the plasma display apparatus according to a first embodiment of the present invention;

FIG. 6 is a plan view illustrating the construction of a plasma display apparatus according to a second embodiment of the present invention;

FIG. 7 is a cross-sectional view illustrating the construction of the plasma display apparatus according to a second embodiment of the present invention;

FIG. 8 is a plan view illustrating the construction of a plasma display apparatus according to a third embodiment of the present invention; and

FIG. 9 is a cross-sectional view illustrating the construction of the plasma display apparatus according to a fourth embodiment of the present invention.

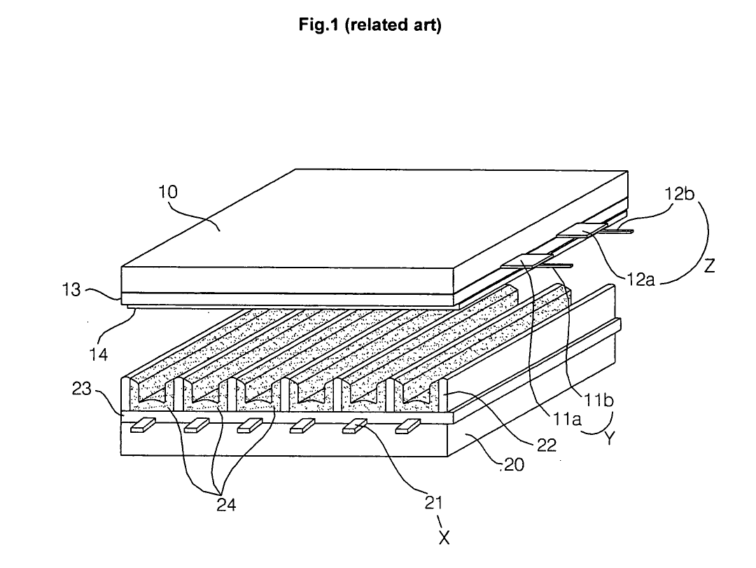

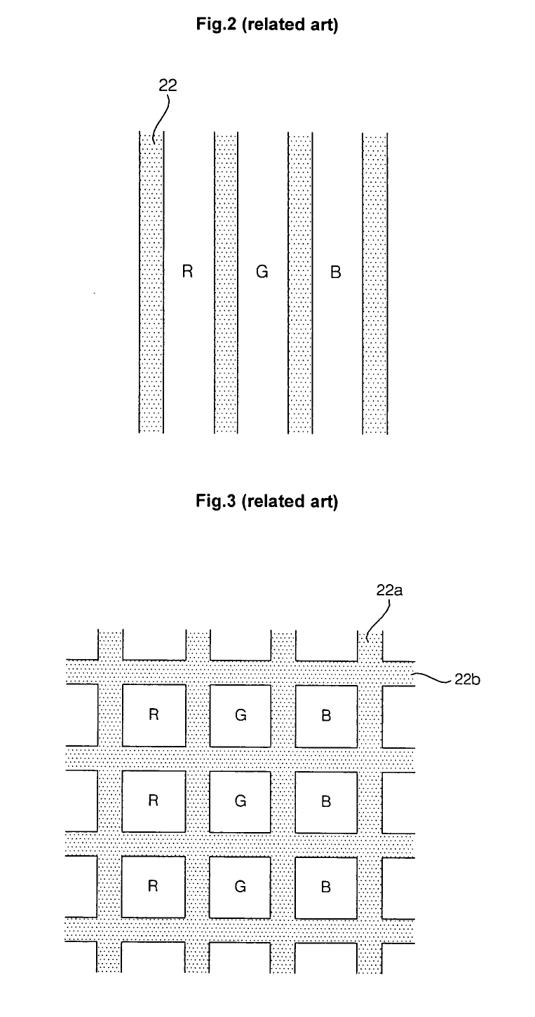

### DETAILED DESCRIPTION OF PREFERRED EMBODIMENTS

The present invention will now be described in connection with preferred embodiments with reference to the accompanying drawings.

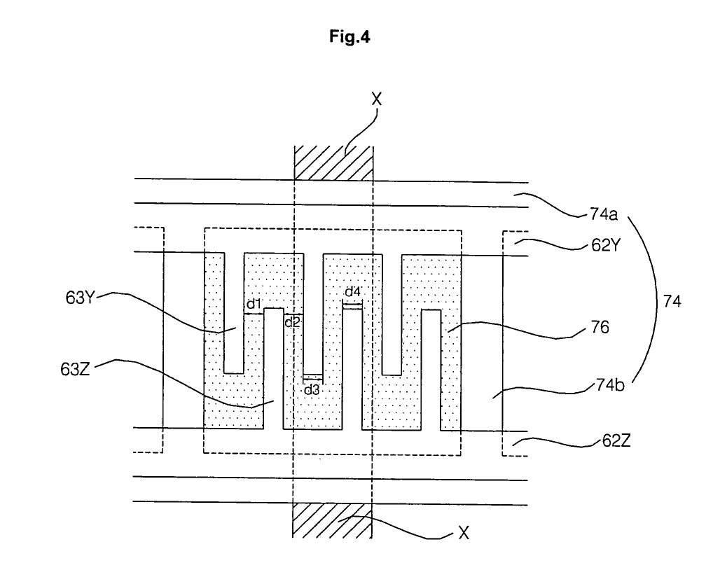

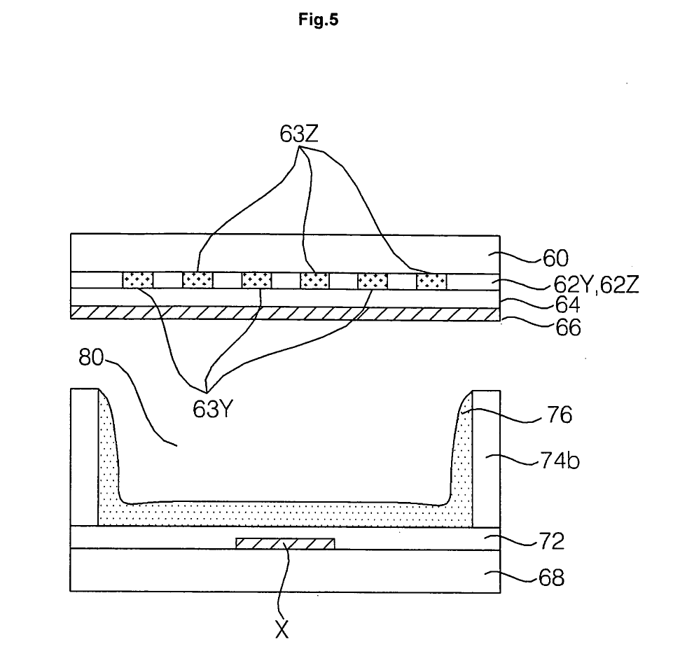

FIG. 4 is a plan view illustrating the construction of a plasma display apparatus according to a first embodiment of the present invention. FIG. 5 is a cross-sectional view illustrating the construction of the plasma display apparatus according to a first embodiment of the present invention.

Referring to FIGS. 4 and 5, in the plasma display apparatus according to the first embodiment of the present invention, a scan bus electrode and a sustain bus electrode formed on an upper substrate 60 include base units 62Y, 62Z, and at least two or more projections 63Y, 63Z projecting from the base units 62Y, 62Z in one discharge cell 80.

In more detail, on a lower substrate 68 are formed horizontal barrier ribs 74a and vertical barrier ribs 74b for partitioning a plurality of discharge cells 80, and an address electrode X formed under the discharge cells 80. The scan bus electrode and the sustain bus electrode are formed on the upper substrate 60 opposite to the lower substrate 68.

At least one or more of the scan bus electrode and the sustain bus electrode include the base units 62Y,62Z crossing the address electrode, and at least two or more projections 63Y,63Z projecting from the base units 62Y,62Z in one discharge cell.

That is, metal electrodes 62Y, 62Z formed on the upper substrate 60 and the address electrode X formed on the lower substrate 68 are included in each discharge cell 80.

The base units 62Y, 62Z are formed to cross the address electrode X on the upper substrate 60. A lower dielectric layer 72 for accumulating wall charges thereon are formed to cover the address electrode X on the lower substrate 68. The horizontal barrier ribs 74a and the vertical barrier ribs 74b for partitioning the discharge cells 80 are formed on the lower dielectric layer 72. At this time, the horizontal barrier ribs 74a are parallel to the base units 62Y, 62Z formed on the upper substrate 60, and the vertical barrier ribs 74b cross the horizontal barrier ribs 74a. The horizontal barrier ribs 74a and the vertical barrier ribs 74b function to prevent ultraviolet rays generated by a discharge and a visible ray, which is excited from phosphors by means of the ultraviolet rays, from leaking to neighboring discharge cells 80. Phosphor 76 is coated on the surfaces of the lower dielectric layer 72, the horizontal barrier ribs 74a and the vertical barrier ribs 74b. The phosphor 76 is excited with ultraviolet rays generated during the discharge of plasma to generate any one visible ray of red, green and blue.

At least one or more of the base unit 62Y of the scan bus electrode and the base unit 62Z of the sustain bus electrode are formed to cross the address electrode X on the upper substrate 60. The projections 63Y, 63Z are projected toward the base units 62Z, 62Y of a counter bus electrode that is opposite to the sustain bus electrode.

That is, the projections 63Y projecting from the base units 62Y of the scan bus electrode project in a direction parallel to the base units 62Z of the sustain bus electrode. The projections 63Z projecting from the base unit 62Z of the sustain bus electrode project in a direction parallel to the base units 62Y of the scan bus electrode.

The base units 62Y, 62Z or the projections 63Y, 63Z can be formed using a metal material having a good conductivity, such as silver (Ag), copper (Cu) or nickel (Ni). In this case, the base units 62Y, 62Z or the projections 63Y, 63Z can be formed as a multi-layer, such as chromium (Cr)/metal electrodes 62Y, 62Z/chromium (Cr), in order to prevent diffusion into the upper dielectric layer 64, or can be formed using a single metal.

At this time, the base units 62Y, 62Z can be formed on the upper substrate 60 so that they are entirely or partially overlapped with the horizontal barrier ribs 74a.

The scan bus electrode or the sustain bus electrode has at least two or more projections 63Y, 63Z that are projected into the discharge cell 80. That is, at least two or more of the projections 63Y formed in the base unit 62Y of the scan bus electrode are projected into the discharge cell 80. At least two or more of the projections 63Z formed in the base units 62Z of the sustain bus electrode are also projected into the discharge cell 80.

Furthermore, the same number of the projections 63Y, 63Z is formed within one discharge cell 80. In other words, if two of the projections 63Y of the scan bus electrode are projected into the discharge cell 80, two of the projections 63Z of the sustain bus electrode are also projected into the discharge cell 80. The projections 63Y, 63Z are projected into the discharge cell 80 parallel to each other. That is, the projections 63Y, 63Z are parallel to the address electrode X.

Furthermore, widths (d1, d2) between the projections 63Y, 63Z can be symmetrical or asymmetrical and widths (d3, d4) between the projections 63Y, 63Z can also be symmetrical or asymmetrical. In other words, the widths (d1, d2) can be set to be the same or different from each other between the projections 63Y of the scan bus electrode and the projections 63Z of the sustain bus electrode.

In a similar way, the width (d3) of the projection 63Y of the scan bus electrode and the width (d4) of the projection 63Z of the sustain bus electrode can be set to be the same or different from each other.

As described above, by controlling the distance between the projections or the width of the projections, the discharge intensity and a discharge location can be properly set within the discharge cell and color temperature can be controlled accordingly.

Furthermore, by setting the number of projection between discharge cells to be different from each other, color temperature of the discharge cell can be controlled. That is, if the number of projections in a B discharge cell of R, G and B discharge cells is set to be larger than that in the remaining discharge cells, a strong discharge is generated in the B discharge cell and color temperature of the B discharge cell can be raised.

Furthermore, dark contrast can be increased by forming a black layer between the base units 62Y, 62Z or the projections 63Y, 63Z and the upper substrate. The black layer can be formed of a black color material. When a discharge is not generated, the black layer makes the screen of the plasma display apparatus look darker, so that a brightness difference with the screen when a discharge is generated becomes great. This makes the picture quality sharp.

An upper dielectric layer 64 for accumulating wall charges generated during the discharge of plasma thereon is formed over the upper substrate 60 on which the base units 62Y, 62Z and the projections 63Y, 63Z are formed. A protection film 66 is formed over the upper substrate 60 on which the upper dielectric layer 64 is formed.

The protection film 66 functions to prevent the upper dielectric layer 64 from being damaged by sputtering generated during the discharge of plasma and thus to improve emission efficiency of secondary electrons. Magnesium oxide (MgO) is generally used as the protection film 66.

Discharge spaces provided between the upper substrate 60 and the lower substrate 68 and between the horizontal barrier ribs 74a and the vertical barrier ribs 74b are filled with an inert gas for discharging a gas.

In the plasma display apparatus constructed above according to the first embodiment of the present invention, the projections 63Y, 63Z are formed within the discharge cell 80 so that a discharge is generated over the entire area of the discharge cell 80. It is thus possible to improve discharge efficiency and emission efficiency. Furthermore, since a discharge distance becomes short by the projections 63Y, 63Z, a discharge firing voltage can be lowered. Therefore, power consumption can be saved since a sufficient discharge can be generated with a low voltage.

Furthermore, in a manufacturing process of a plasma display apparatus, a manufacturing process can be reduced and a manufacturing time can be shortened because transparent electrodes are not formed. Therefore, the cost of the plasma display apparatus can be lowered.

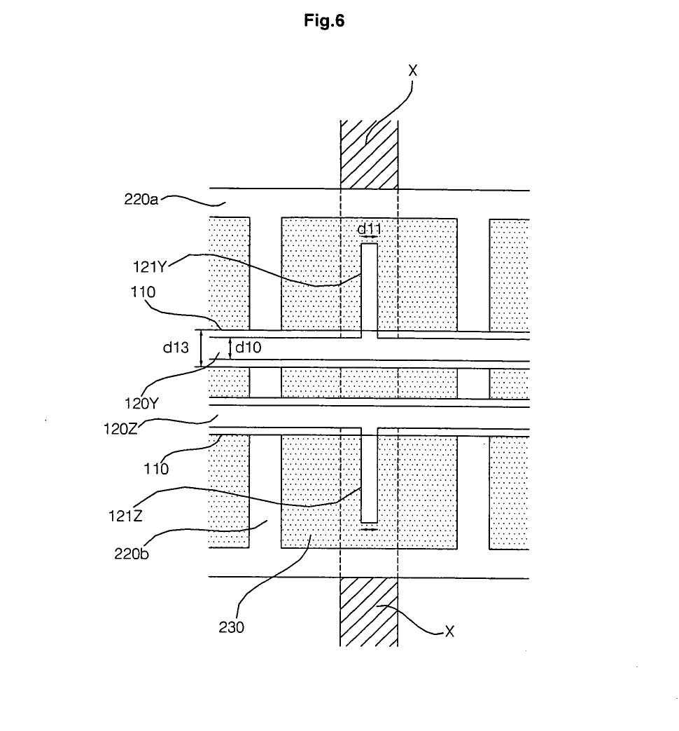

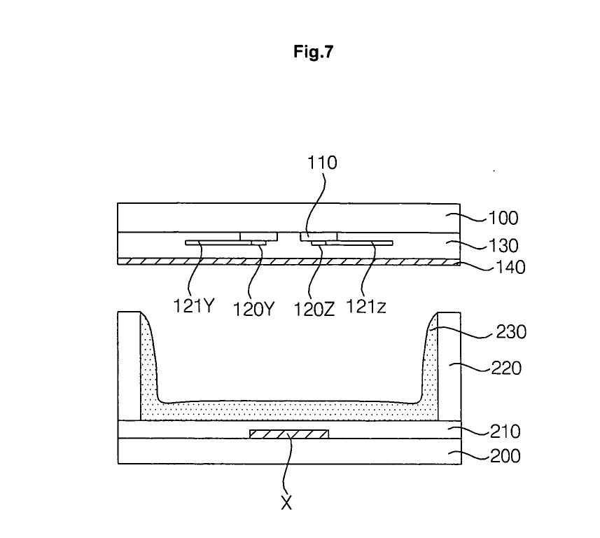

FIG. 6 is a plan view illustrating the construction of a plasma display apparatus according to a second embodiment of the present invention. FIG. 7 is a cross-sectional view illustrating the construction of the plasma display apparatus according to a second embodiment of the present invention.

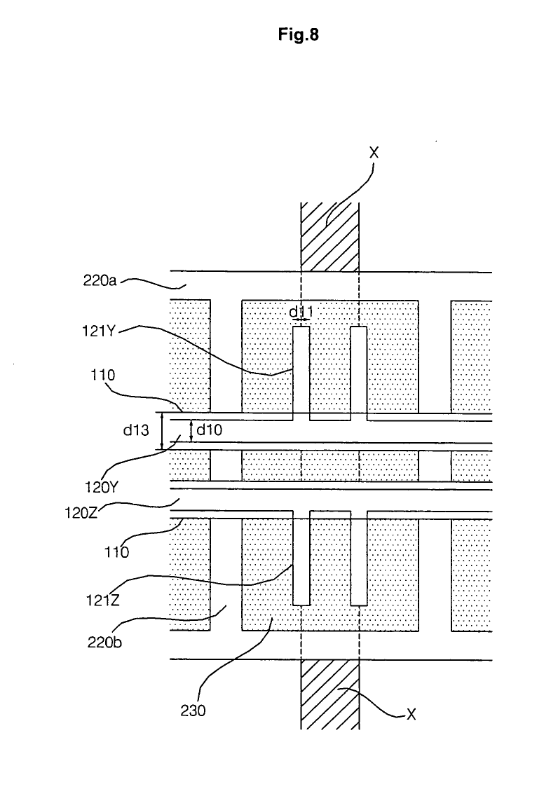

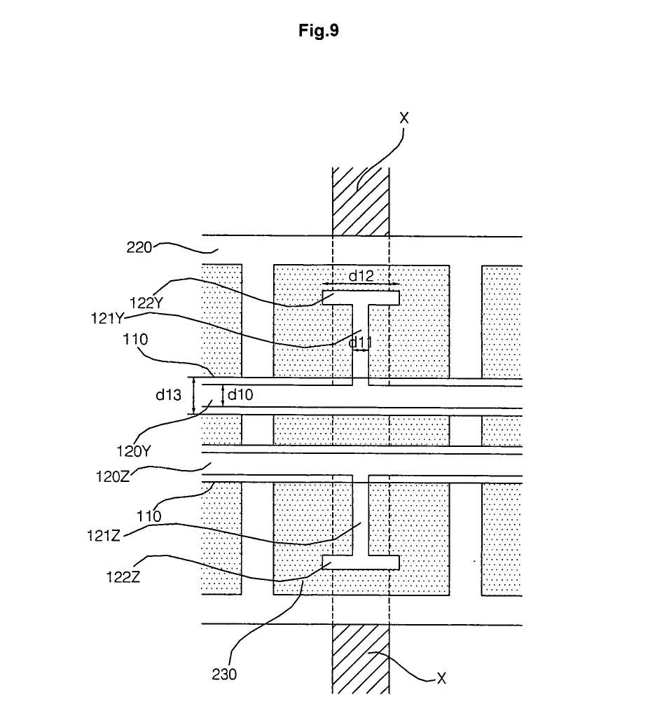

Furthermore, FIG. 8 is a plan view illustrating the construction of a plasma display apparatus according to a third embodiment of the present invention. FIG. 9 is a cross-sectional view illustrating the construction of the plasma display apparatus according to a fourth embodiment of the present invention.

In the plasma display apparatus according to the present invention, a scan bus electrode and a sustain bus electrode include base units 120Y, 120Z crossing an address electrode X, and at least one or more projections 121Y, 121Z that project from the base units 120Y, 120Z in one discharge cell. The projections 121Y, 121Z are projected in an opposite direction to the base units 120Z, 120Y of counter bus electrodes that are opposite to each other.

The number of the projection 121Y of the scan bus electrode and the projection 121Z of the sustain bus electrode can be the same in each discharge cell or can be different from each other every discharge cell. However, the number of the projection 121Y of the scan bus electrode and the projection 121Z of the sustain bus electrode can be preferably the same number in one discharge cell.

Furthermore, the number of the projections can be irregular every discharge cell depending on the structure of a discharge cell and/or a discharge state, in order to control color temperature and the like. In a particular discharge cell, the number of the projections can be increased in order to generate a strong discharge and to raise color temperature of the discharge cell. For example, to raise color temperature, the number of projections can be larger in a blue (B) discharge cell than in a red (R) discharge cell or a green (G) discharge cell.

More particularly, in the plasma display apparatus according to the second embodiment of the present invention, the base unit 120Y of the scan bus electrode and the base unit 120Z of the sustain bus electrode can be spaced apart from each other at a predetermined distance at the center of the discharge cell in parallel, and one projection can be provided in one discharge cell every bus electrode. In this case, the projection 121Y of the scan bus electrode is projected from the base unit 120Y of the scan bus electrode to the outside wall of the discharge cell. Furthermore, the projection 121Z of the sustain bus electrode is also projected from the base unit 120Z of the scan bus electrode to the outside wall of the discharge cell.

That is, the projection 121Y of the scan bus electrode and the projection 121Z of the sustain bus electrode are parallel to each other. Furthermore, the projections 121Y, 121Z can be projected parallel to the address electrode X or can be slightly tilted from the address electrode X.

The projections can be overlapped with the address electrode X.

Furthermore, a width (d11) of the projection can be substantially narrower than a width (d10) of the base unit.

A black layer 110 is formed between the base unit and the upper substrate in order to enhance dark contrast. The black layer 110 can have a width wider than that of the base unit by some degree. That is, a width (d13) of the black layer 110 is wider than the width (d10) of the base unit. The black layer 110 can be formed using a black color material.

Referring to FIG. 8, in the plasma display apparatus according to the third embodiment of the present invention, the number of projections 121Y, 121Z projecting from base units 120Y, 120Z of a scan bus electrode or a sustain bus electrode is two in one discharge cell.

In this case, the remaining constructions and operations are substantially the same as those of the second embodiment. Therefore, description thereof will be omitted in order to avoid redundancy.

Referring to FIG. 9, in the plasma display apparatus according to the fourth embodiment of the present invention, projections include first projections 121Y, 121Z, which are connected to base units 120Y, 120Z, respectively, and have a narrow width, and second projections 122Y, 122Z having a width wider than that of the first projections.

Meanwhile, the remaining constructions and operations other than the structure of the projections are substantially the same as those of the second embodiment or the third embodiment. Therefore, description thereof will be omitted in order to avoid redundancy.

The first projections 121Y, 121Z are connected to the base units 120Y, 120Z, respectively, and the second projections 122Y, 122Z are connected to the other ends of the first projections 121Y, 121Z. That is, if the second projections 122Y, 122Z are formed at the distal ends of the first projections 121Y, 121Z, respectively, they generally have a T shape.

In this case, a discharge can be uniformly generated over the whole discharge cell in comparison with the second embodiment or the third embodiment. In the case where the second projections 122Y, 122Z are formed in the middle of the first projections 121Y, 121Z, they generally have a cross shape.

The first projections 121Y, 121Z or the second projections 122Y, 122Z are also metal electrodes. The number and shape of the projections of the scan bus electrode, and the number and shape of the projections of the sustain bus electrode can be the same in one discharge cell.

Furthermore, the second projection 122Y of the scan bus electrode and the second projection 122Z of the sustain bus electrode can have the same number in one discharge cell. However, the projections and/or the second projections can have a different number in each discharge cell depending on the property of each discharge cell.

Furthermore, the projections can have a width, which is substantially narrower than that of the base units 120Y, 120Z. The first projections 121Y, 121Z are connected to the base units, respectively, and can have a width (d11) narrower than a width (d10) of the base units. The second projections 122Y, 122Z are connected to one ends of the first projections 121Y, 121Z, respectively, and can have a width (d12) wider than the width (d11) of the first projections 121Y, 121Z. The width (d12) of the second projections 122Y, 122Z refers to a width along which the base units 120Y, 120Z are formed, i.e., a transverse width. A longitudinal width of the second projections 122Y, 122Z can be substantially the same as the width (d11) of the first projections 121Y, 121Z, or can be substantially narrower than the width (d10) of the base units 120Y, 120Z.

The first projections 121Y, 121Z or the second projections 122Y, 122Z can be overlapped with the address electrode X entirely or partially.

In a similar way as other embodiments, a black layer 110 is formed between the base units and the upper substrate in order to enhance dark contrast. The black layer 110 can be formed wider than the base unit by a predetermined margin value (d12-d10). That is, the width (d13) of the black layer 110 can be wider than the width (d10) of the base unit. The black layer 110 can be formed using a black color material.

The remaining constructions are substantially the same as that of the second embodiment or the third embodiment. Therefore, description thereof will be omitted in order to avoid redundancy.

In the second to fourth embodiments of the present invention, a discharge is generated in the base units that are spaced apart one another at regular intervals at the center of the discharge cell. The discharge is then diffused into the projections connected to the base units so that it has an influence on the entire discharge cell.

A distance between the base unit of the scan bus electrode and the base unit of the sustain bus electrode becomes a discharge gap.

As described above, in accordance with the plasma display apparatus according to the second to fourth embodiments of the present invention, the base unit of the scan bus electrode and the base unit of the sustain bus electrode are closely located within the discharge cell, and the projections are formed at the remaining discharge cell spaces. Therefore, since a discharge can be generated over the entire area of the discharge cell, discharge efficiency and emission efficiency can be improved accordingly. Furthermore, since the base units are closely located at the center of the discharge cell, a discharge distance can become short and a discharge firing voltage can be lowered. Therefore, since a sufficient discharge can be generated even with a low voltage, power consumption can be saved.

Furthermore, in a similar way as the first embodiment, in a manufacturing process of a plasma display apparatus, a manufacturing process can be reduced and a manufacturing time can be shortened because transparent electrodes are not formed. Therefore, the cost of the plasma display apparatus can be lowered.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
horizontal barrier ribs and vertical barrier ribs formed on a lower substrate, for partitioning a discharge cell;
an address electrode formed under the discharge cell;
a scan bus electrode and a sustain bus electrode formed on an upper substrate opposite to the lower substrate,
wherein at least one or more of the scan bus electrode and the sustain bus electrode comprise base units crossing the address electrode, and at least two or more projections projecting from the base units in one discharge cell.

2. The plasma display apparatus as claimed in claim 1, wherein the projections are projected toward the base units of counter bus electrodes that are opposite to each other.

3. The plasma display apparatus as claimed in claim 1, wherein the projection of the scan bus electrode and the projection of the sustain bus electrode are parallel to each other.

4. The plasma display apparatus as claimed in claim 1, wherein a distance between the projections is asymmetrical.

5. The plasma display apparatus as claimed in claim 1, wherein a width of the projections is asymmetrical.

6. The plasma display apparatus as claimed in claim 1, wherein at least one or more of the projections are overlapped with the address electrode.

7. The plasma display apparatus as claimed in claim 1, wherein the base units are partially overlapped with the horizontal barrier ribs.

8. The plasma display apparatus as claimed in claim 1, wherein the projection of the scan bus electrode and the projection of the sustain bus electrode have the same number in one discharge cell.

9. The plasma display apparatus as claimed in claim 1, wherein the projections are alternately projected together with the projections of the counter bus electrodes.

10. The plasma display apparatus as claimed in claim 9, wherein a distance from the end of the projection to the base unit of the counter bus electrode is shorter than the length of the projection.

11. A plasma display apparatus comprising:
barrier ribs formed on a lower substrate, for partitioning a discharge cell;
an address electrode formed under the discharge cell;
a scan bus electrode and a sustain bus electrode formed on an upper substrate opposite to the lower substrate,
wherein the scan bus electrode and the sustain bus electrode comprise base units crossing the address electrode, and at least one or more projections projecting from the base units in one discharge cell, and
the projections are projected in a direction opposite to the base units of counter bus electrodes that are opposite to each other.

12. The plasma display apparatus as claimed in claim 11, wherein the projection of the scan bus electrode and the projection of the sustain bus electrode are parallel to each other.

13. The plasma display apparatus as claimed in claim 11, wherein the projections have a width, which is substantially narrower than that of the base units.

14. The plasma display apparatus as claimed in claim 11, wherein the projections are parallel to the address electrode.

15. The plasma display apparatus as claimed in claim 11, wherein the projection of the scan bus electrode and the projection of the sustain bus electrode have the same number in one discharge cell.

16. The plasma display apparatus as claimed in claim 11, wherein the projections comprise a first projection, which is connected to the base unit and has a narrow width, and a second projection having a width wider than that of the first projection.

17. The plasma display apparatus as claimed in claim 16, wherein the first projection and the second projection are metal electrodes.

18. The plasma display apparatus as claimed in claim 17, wherein the second projection of the scan bus electrode and the second projection of the sustain electrode have the same number in one discharge cell.

19. The plasma display apparatus as claimed in claim 11, further comprising a black layer formed between the base unit and the upper substrate.

20. The plasma display apparatus as claimed in claim 19, wherein, the black layer has a width wider than that of the base units.
